(19) United States
(12) Patent Application Publication
(10) Pub. No.: US 2013/0103742 A1
(43) Pub. Date: Apr. 25, 2013

(54) DIRECT PHOTO SHARING SYSTEM

(71) Applicant: Chen-Ning Hsi, Taipei (TW)

(72) Inventor: Chen-Ning Hsi, Taipei (TW)

(73) Assignee: PRIMAX ELECTRONICS LTD., Taipei (TW)

(21) Appl. No.: 13/397,406

(22) Filed: Feb. 15, 2012

(30) Foreign Application Priority Data
Oct. 19, 2011 (TW) 100137869

(51) Int. Cl. G06F 15/16

(52) U.S. Cl. 709/203

(57) ABSTRACT

A direct photo sharing system includes a photo sharing browser and a photo sharing platform. Through the photo sharing browser, the user may browse and share at least one photo. The photo sharing browser includes a browsing history recording module for recording a browsing history of the at least one photo and a photo selecting module for allowing the user to select a photo to be shared and issuing a sharing indicator. The photo sharing platform is used for storing the at least one photo and the browsing history of the photo and transmitting the sharing indicator. The photo sharing platform includes a photo file management module and a photo recommendation module. The photo file management module manages at least one photo folder. The photo recommendation module gathers statistics and performs analysis on the browsing history of the photo, thereby generating at least one recommendation notification signal.

### FIELD OF THE INVENTION

The present invention relates to a direct sharing system for sharing digital images, and more particularly to a direct photo sharing system for sharing photos.

### BACKGROUND OF THE INVENTION

A photo sharing method is a way of making contact with good friends and family through networking environments and electronic devices. Nowadays, the photo sharing method becomes more and more popular. For example, in a case that the photo sharing method is used in a social networking website to share photos, all of the sharer and the contact persons (e.g. the friends and family of the sharer) should have their user accounts of the social networking website. Once the photos are uploaded to the social networking website, the photos uploaded by the sharer can be viewed by all of the contact persons. Generally, the sharer may create a group to store a list of contact persons in order to limit the number of members viewing the photos.

However, since the way of adjusting the members of the group is very rigid to the sharer, it is difficult to adjust the subject to be shared in real time. Moreover, in views of the photo feedback, the sharer may only passively wait for the feedback messages from the receivers. Moreover, for sharing photos, the sharers need to individually choose photos from their own electronic devices or other user accounts and then upload the photos to the social networking website. The way of sharing photos is very slow. If the number of photos is too huge, the procedures of choosing photos and selecting the to-be-shared receivers become more troublesome. Sometimes, the pleasure of sharing photos by the sharers will be alleviated. Moreover, when the sharers want to choose the to-be-shared receivers, the shares usually fail to immediately confirm the to-be-shared receivers from the contact information of the contact persons. If the to-be-shared receiver is erroneously chosen, unnecessary troublesome matters may occur.

Moreover, in a case that the receiver wants to realize the contents of the shared photos the receiver needs to open the photo files to view the photos. If the number of photos is too huge, the procedures of repeatedly opening the photo files are inconvenient to the receiver.

Therefore, there is a need of providing a direct photo sharing system so as to obviate the drawbacks encountered from the prior art.

### SUMMARY OF THE INVENTION

The present invention relates to a direct photo sharing system including a photo sharing browser. The photo sharing browser is installed in an electronic device of a consumer (i.e. a user). A photo sharing platform is installed in a cloud server. The photo sharing platform is served as an agent for managing the photo-sharing and photo-transferring action. Consequently, the photos may be roamed and viewed in different electronic devices at different places and at different time.

The present invention also relates to a direct photo sharing system. A photo file management module of a photo sharing platform is used to manage sharing and transmission of photos, so that only some specified photos shared by the sharer can be viewed by different receivers.

The present invention also relates to a direct photo sharing system with a browsing history recording module for recording the browsing history of at least one photo. Consequently, the records about the procedures of editing photos, sharing photos to the sharer and sharing photos to the receiver can be tracked, and the feedback messages of the shared photos can be recorded.

The present invention also relates to a direct photo sharing system, in which a sharing notification generating module of a photo sharing platform is used to generate an ordinary notification signal or a special notification signal to a receiver so as to recommend the receiver to view the shared photos.

The present invention also relates to a direct photo sharing system for managing the transmission channel of sharing photos. The frequently-used channels are acquired according to the browsing histories of the photos, so that a frequently-used channel list is generated. After one sharing channel is selected from the frequently-used channel list by the user, the photo can be transmitted through the selected channel.

In accordance with an aspect of the present invention, there is provided a direct photo sharing system for use in a network environment. The direct photo sharing system includes a photo sharing browser and a photo sharing platform. The photo sharing browser is installed in an electronic device for allowing a user to browse and share at least one photo by operating the electronic device. The photo sharing browser includes a browsing history recording module and a photo selecting module. The browsing history recording module is used for recording a browsing history of the at least one photo. The photo selecting module is used for allowing the user to select a photo to be shared and issuing a sharing indicator. The photo sharing platform is installed in a cloud server for storing the at least one photo and the browsing history of the photo, and transmitting the sharing indicator to a second electronic device. The electronic device and the second electronic device are in communication with the cloud server through an internet. The photo sharing platform includes a photo file management module and a photo recommendation module. The photo file management module is used for managing at least one photo folder, wherein the photo is stored in the photo folder. The photo recommendation module is used for gathering statistics and performing analysis on the browsing history of the photo, thereby generating at least one recommendation notification signal.

In an embodiment, the photo sharing browser further includes a photo searching module for searching and displaying all photos of the electronic device, wherein if all of the photos include at least one new photo, the at least one new photo is marked by the photo searching module.

In an embodiment, the photo sharing browser further includes a transmission channel recommendation module. According to a plurality of counts of plural sharing channels used by the electronic device, the transmission channel recommendation module generates a frequently-used channel list. After one sharing channel is selected from the frequently-used channel list by the user, the photo is transmitted to the second electronic device through the selected sharing channel, wherein the sharing channel is a Wi-Fi sharing channel, a 3G sharing channel or a Bluetooth sharing channel.

In an embodiment, the photo selecting module is operated in a manual sharing mode or an automatic sharing mode. When the photo selecting module is operated in the automatic sharing mode, plural to-be-shared photos are classified according to face images contained in the to-be-shared photos.

In an embodiment, the browsing history includes a name of the user who browses the photo, a count of the photo browsed, a time length of browsing the photo in each browsing action, an action of enlarging, shrinking or moving the photo, a count of the photo downloaded to any electronic device, a name of a folder of any electronic device which stores the photo, and a count of the photo re-shared.

In an embodiment, a content of the recommendation notification signal is determined according to a user account.

In an embodiment, the photo sharing platform further comprises a sharing notification generating module for issuing a notification signal to a receiver. Moreover, if the receiver has no user account, the notification signal is sent to the receiver through an electronic mail box, a short message or a social networking website account, wherein if the receiver has a user account, the notification signal is shown on a photo sharing browser of the receiver. Optionally, when the notification signal is shown on the photo sharing browser of the receiver, the notification signal contains a face image of the user and a face image of the receiver.

In an embodiment, the photo sharing browser further includes a face address book creating module for allowing the user to create a face address book. The face address book includes information about face images, names, telephone numbers and plural name-related contact data. Moreover, the face images are added to the face address book by a cursor-dragging operation. After a new photo with a face image is received by the photo sharing browser, if the face image is not included in the face address book, a new contact creating prompt is generated by the face address book creating module. Moreover, the face address book creating module further provides a function of assigning face identification codes, wherein different identification codes are assigned to the face images in the plural photos of the electronic device, and the identification codes are recorded in the face address book.

In an embodiment, the photo sharing platform further comprises a photo rating module, wherein by the photo rating module, plural photos in the photo sharing platform are classified to have at least one rating. Moreover, the rating is determined according to the browsing history of the photo. Alternatively, the rating is determined according to an imaging quality of the photo.

In an embodiment, the photo sharing browser further includes a photo packing and playing module for selecting plural photos and packing the selected photos into a photo package according to a photo attribute, and generating a space setting parameter, a time setting parameter, an animation effect setting parameter and a background music setting parameter, and playing the photo package according to a playing sequence of the photo package in response to a playing command. For example, the photo attribute is a photo shot time, a people action in photo, a face image or a photo subject. Optionally, the photo packing and playing module provides plural packing templates, wherein according to the packing templates, plural photos are selected by the user to be packed into the photo package. Alternatively, the photo package is transmitted to the photo sharing platform and shared to at least one indicated receiver.

In an embodiment, the photo sharing browser further includes a photo editing module for editing the photo.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a direct photo sharing system according to an embodiment of the present invention;

FIG. 2 is a schematic functional block diagram illustrating a method for roaming and viewing the digital image file by the direct photo sharing system according to a first embodiment of the present invention;

FIG. 3 is a schematic functional block diagram illustrating a method for sharing and viewing the digital image file by the direct photo sharing system according to a second embodiment of the present invention;

FIG. 4 is a schematic functional block diagram illustrating a method for sharing and viewing the digital image file by the direct photo sharing system according to a third embodiment of the present invention;

FIG. 5 is a schematic functional block diagram illustrating a method for sharing and viewing the digital image file by the direct photo sharing system according to a fourth embodiment of the present invention;

FIG. 6 is a schematic functional block diagram illustrating a method for sharing and viewing the digital image file by the direct photo sharing system according to a fifth embodiment of the present invention;

FIG. 7 is a schematic functional block diagram illustrating a way to create a sharing name list by the direct photo sharing system of the present invention; and

FIG. 8 is a schematic functional block diagram illustrating a method for sharing and viewing the digital image file by the direct photo sharing system according to a sixth embodiment of the present invention.

### DETAILED DESCRIPTION OF THE PREFERRED EMBODIMENT

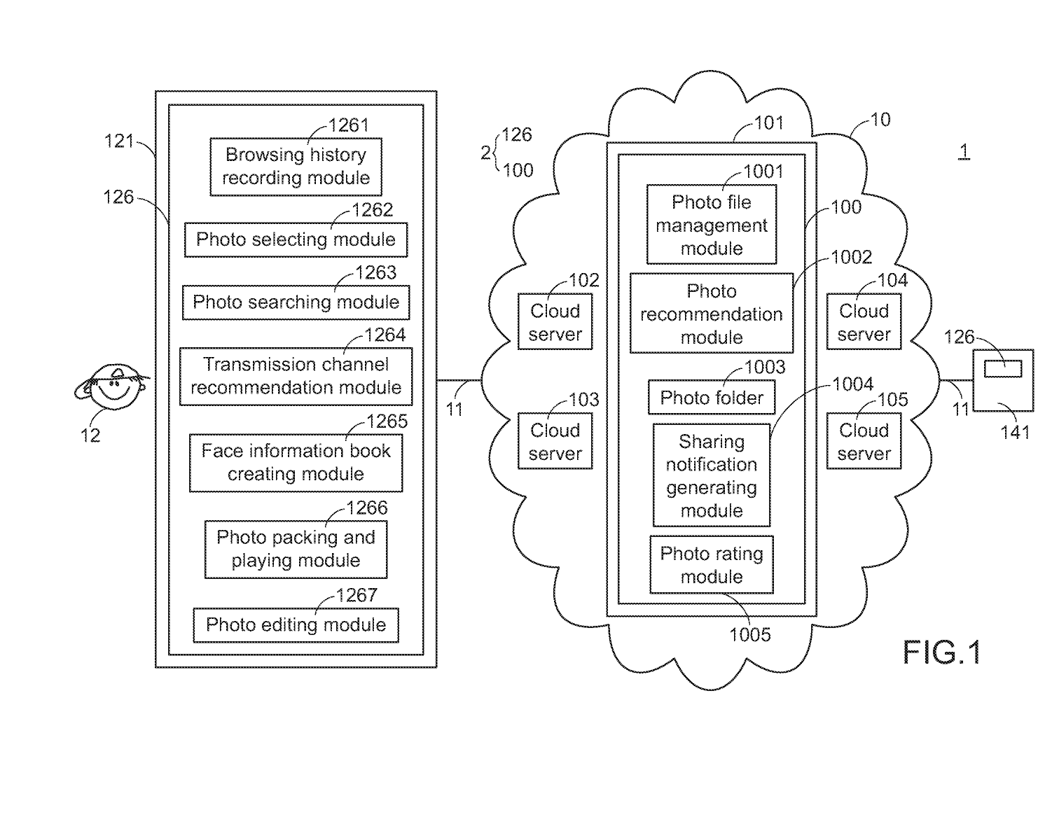

FIG. 1 schematically illustrates the architecture of a direct photo sharing system according to an embodiment of the present invention. As shown in FIG. 1, the direct photo sharing system is applied to a network environment 1. The network environment 1 includes a user 12, an electronic device 121, a photo sharing browser 126, and an internet 10. In this embodiment, the photo sharing browser 126 is included in the electronic device 121. The electronic device 121 of the user is in communication with the internet 10 through a connecting channel 11. The internet 10 at least comprises a cloud server 101 and a photo sharing platform 100. The photo sharing platform 100 is included in the cloud server 101. In this embodiment, the direct photo sharing system 2 comprises the photo sharing browser 126 and the photo sharing platform 100.

In this embodiment, the connecting channel 11 is a wireless or wired channel. Consequently, the electronic device 121 of the user 12 is in communication with the internet 10 through the connecting channel 11 by a wireless transmission technology or a wired transmission technology. For example, the wireless transmission technology includes a telecommunication technology for a mobile phone, a wireless network communication technology, or the like. For example, the wired transmission technology includes a local telephone telecommunication technology, a cable television transmission technology, a home plug powerline networking technology, or a leased-line or broadband network transmission technology, or a combination of at least two of the above wired transmission technologies.

An example of the electronic device 121 includes but is not limited to a desktop computer, a portable computer, a tablet personal computer, a mobile phone, a video camera, a digital camera or a digital photo frame. It is noted that plural electronic devices may be in communication to transfer files through the connecting channel or directly transfer files in a peer-to-peer manner. Moreover, the electronic device may be equipped with a storage module for storing a digital image file. For example, the electronic device is equipped with a hard disc or a memory for storing the digital image file. Moreover, the electronic device may access a digital image file from another storing module. For example, the electronic device may access a digital photo file from a portable flash memory.

The digital photo file stored in the electronic device may be used as the photo source of the direct photo sharing system 2 for providing photos to be shared by the user 12. The photo source of the direct photo sharing system 2 is not limited to the digital photo file stored in the electronic device. In some embodiments, the photo source of the direct photo sharing system 2 further includes the photo file that is stored in the cloud server 101, 102, 103, 104 or 104 and owned by the user 12. For example, if the user 12 is registered to the social networking website “Facebook”, the uploaded photo file corresponding to the Facebook account may be stored in the cloud server 101 and 102 of the internet 10. Moreover, if the user 12 has a Gmail account and is registered to the Gmail account, the photo file transferred by a third party and attached on the electronic mail may be stored in the cloud server 103. Likewise, the photo file stored in the internet 10 and owned by the user 12 may be used as the photo source of the direct photo sharing system 2.

The photo sharing browser 126 is installed in the electronic device 121 of the user 12. By operating the electronic device 121, the user 12 can browse and share at least one photo. The photo sharing browser 126 includes a browsing history recording module 1261 and a photo selecting module 1262. The browsing history recording module 1261 is used for recording the browsing history of the at least one photo. The photo selecting module 1262 is used for allowing the user 12 to select a photo to be shared and issuing a sharing indicator.

The photo sharing platform 100 is used for storing the at least one photo and the browsing history of the photo, and transmitting the sharing indicator to another electronic device 141. The electronic devices 121 and 141 are in communication with the cloud server 101 through the internet 10. The photo sharing platform 100 includes a photo file management module 1001 and a photo recommendation module 1002. The photo file management module 1001 is used for managing at least one photo folder 1003. The photo folder 1003 is used for storing the photo. The photo recommendation module 1002 is used for gathering statistics and performing analysis on the browsing history of the photo, thereby generating at least one recommendation notification signal.

In an embodiment, the photo sharing browser 126 further includes a photo searching module 1263 for searching and displaying all of the photos in the electronic device 121. Moreover, if all of the photos include at least one new photo, the new photo may be marked by the photo searching module 1263. Moreover, the photo sharing browser 126 further includes a transmission channel recommendation module 1264. According to a plurality of counts of plural sharing channels used by the electronic device 121, the transmission channel recommendation module 1264 generates a frequently-used channel list. After one sharing channel is selected from the frequently-used channel list by the user 12, the photo can be transmitted to another electronic device 141 through the selected channel. An example of the sharing channel includes but is not limited to a Wi-Fi sharing channel, a 3G sharing channel or a Bluetooth sharing channel. Moreover, the photo sharing browser 126 further includes a face address book creating module 1265. The face address book creating module 1265 is used for allowing the user 12 to create a face address book. The face address book includes the information about face images, names, telephone numbers and plural contact data related to the names. Moreover, the photo sharing browser 126 further includes a photo packing and playing module 1266. The photo packing and playing module 1266 is used for selecting plural photos and packing the selected photos into a photo package according to a photo attribute. In addition, the photo packing and playing module 1266 is used for automatically or manually generating a space setting parameter, a time setting parameter, an animation effect setting parameter, a background music setting parameter, or a combination of at least two of the above setting parameters. Moreover, in response to a playing command, the photo packing and playing module 1266 will play the photo package according to a playing sequence of the photo package. The photo package is transmitted to the photo sharing platform 100 in order to be shared to at least one indicated receiver. Moreover, the photo sharing browser 126 further includes a photo editing module 1267 for editing the photo.

In an embodiment, the photo sharing platform 100 further includes a sharing notification generating module 1004 for issuing a notification signal to a receiver. Moreover, the photo sharing platform 100 further includes a photo rating module 1005. By the photo rating module, the plural photos in the photo sharing platform 100 are classified to have at least one rating.

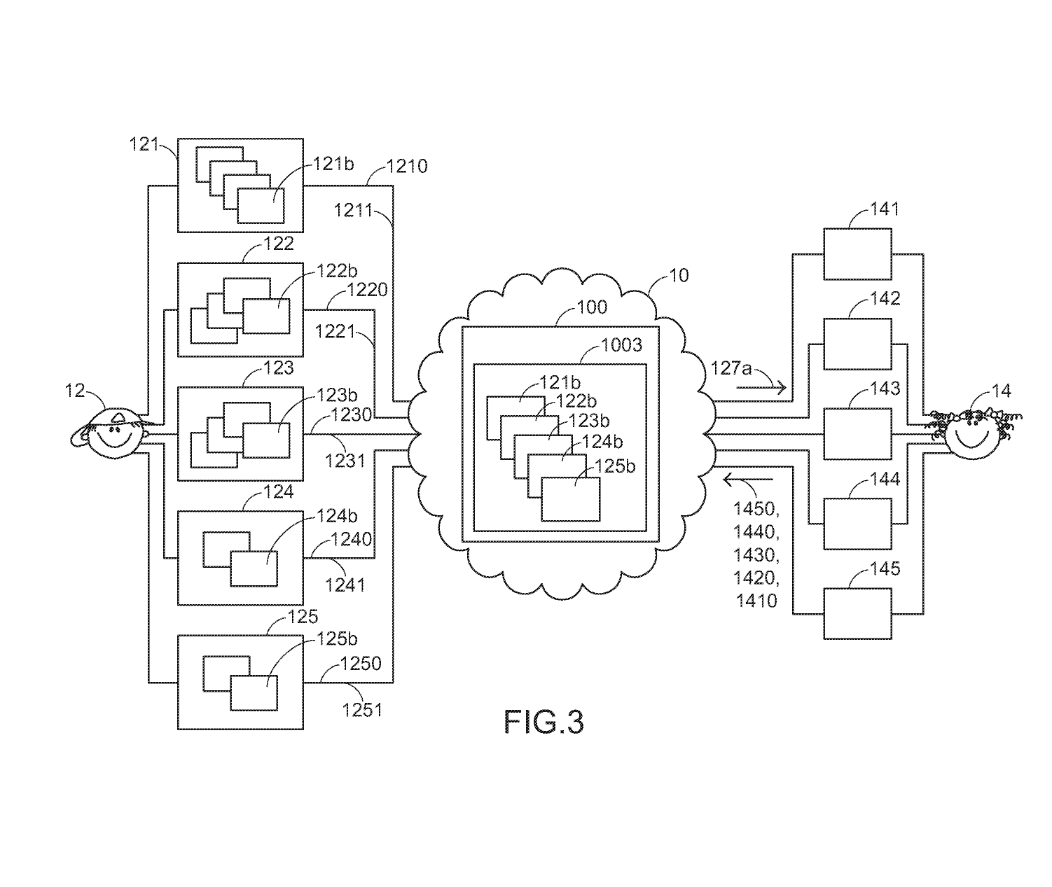

The operations of the direct photo sharing system of the present invention will be illustrated in more details as follows. In the direct photo sharing system, the photo sharing browsers included in the electronic devices are operated by plural users and the photo sharing platform 100 is cooperatively used to process the photos, so that a function of directly sharing photos is achieved. In the following descriptions, the user 12 is a photo sharer, and the user 14 (see FIG. 3) is a photo receiver. In practical applications, the direct photo sharing system includes plural users 12 and plural users 14, wherein the photos are simultaneously or individually shared to the plural users 14 by the plural users 12. Moreover, the direct photo sharing system may be used to share photos from one user to one user, from one user to many users, from many users to one user, or from many users to many users. Alternatively, the user 12 (or the user 14) may share photos between the own electronic device and the user account stored in the internet.

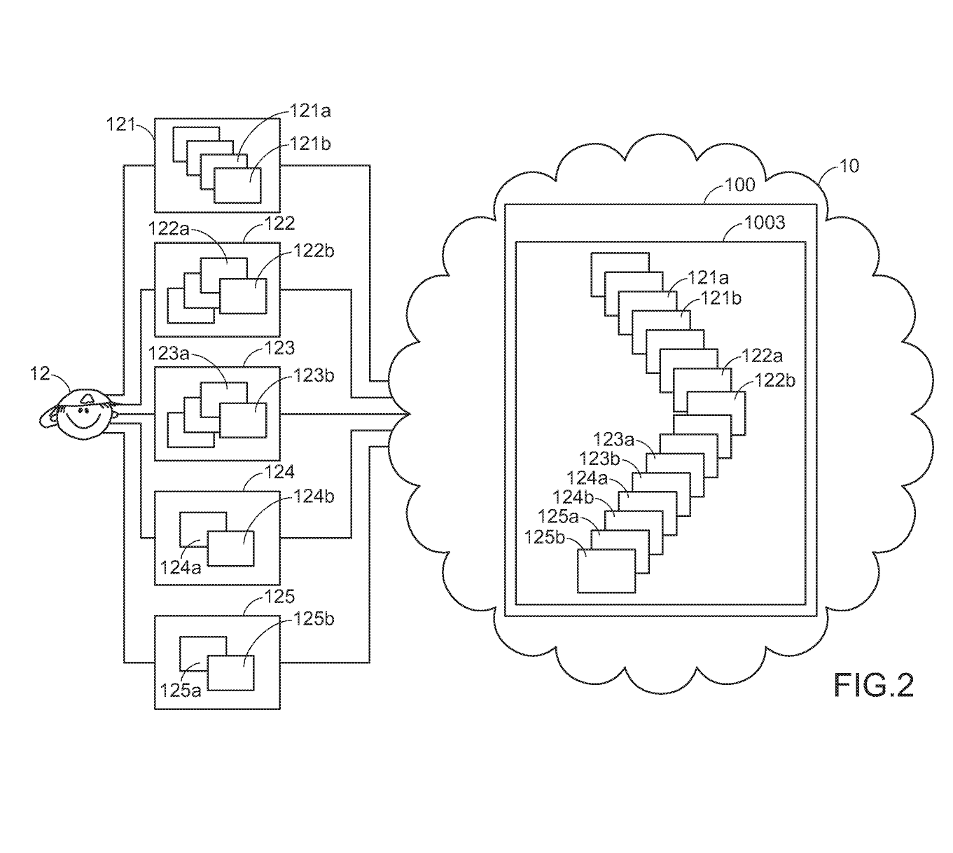

Moreover, the direct photo sharing system of the present invention may be used to roam and view photos and further share the digital image file that is owned by the user. The digital image file owned by the user may be stored in any electronic device at the user's side or the electronic device in the internet. FIG. 2 is a schematic functional block diagram illustrating a method for roaming and viewing the digital image file by the direct photo sharing system according to a first embodiment of the present invention. Please refer to FIGS. 1 and 2. Each of the electronic devices 121, 122, 123, 124 and 125 is equipped with a photo sharing browser 126 and in communication with the internet 10. After each of the electronic devices 121, 122, 123, 124 and 125 is equipped with the photo sharing browser 126, these electronic devices may be in communication with the photo sharing platform 100 according to a user account, so that the purpose to roam and view the digital image file is achievable. Moreover, in an embodiment, the photos 121a and 121b stored in the electronic device 121 may be produced or refreshed at different time spots. Similarly, the photos 122a and 122b are stored in the electronic device 122; the photos 123a and 123b are stored in the electronic device 123; the photos 124a and 124b are stored in the electronic device 124; and the photos 125a and 125b are stored in the electronic device 125.

For example, the electronic device 121 is operated by the user 12 to be connected to the internet 10. In addition, the photo sharing browser 126 is installed in the electronic device 121. According to a user account, the electronic device 121 is in communication with the photo sharing platform 100. In an embodiment, the photos 121a and 121b are automatically searched and displayed by the photo searching module 1263 of the photo sharing browser 126. The photo selecting module 1262 may be operated in a manual sharing mode or an automatic sharing mode. In the manual sharing mode, if the photos 121a and 121b are successively browsed by the user 12 through the photo sharing browser 126, respective browsing histories of the photos 121a and 121b are recorded in the browsing history recording module 1261. In this context, the browsing history includes but is not limited to the name of the user who browses the photo 121a (or 121b), a count of the photo 121a (or 121b) browsed, the time length of browsing the photo 121a (or 121b) in each browsing action, a count of the photo 121a (or 121b) downloaded to any of the electronic devices, the name of a folder of any electronic device which stores the photo 121a (or 121b), a count of the photo 121a (or 121b) re-shared, and the action of magnifying, minifying or moving the photo 121a (or 121b) during the photo 121a (or 121b) is viewed.

In a case that the photo 121a or the photo 121b or both of the photos 121a and 121b are selected by the user 12, the photo selecting module 1262 issues a corresponding sharing indicator. Moreover, the corresponding browsing history recorded in the browsing history recording module 1261 is transmitted to and stored in the photo folder 1003 of the photo sharing platform 100. Moreover, the photos to be stored in the cloud server 101 or 102 of the internet 10 may be selected by the user 12 through the photo selecting module 1262. At the same time, the browsing history corresponding to the selected photo is also recorded in the browsing history recording module 1261. Once any photo is selected and uploaded to the photo sharing platform 100 by the user 12 through the photo selecting module 1262, the photo selecting module 1262 will issue a sharing indicator, and the browsing history recorded in the browsing history recording module 1261 will be stored in the photo folder 1003 of the photo sharing platform 100.

Moreover, after the sharing indicator from the photo selecting module 1262 is transmitted to the photo sharing platform 100, the sharing indicator may be transmitted to another electronic device (e.g. the electronic device 122 of the user 12) through the photo file management module 1001. After the electronic device 122 is operated by the user 12 to be connected to the internet 10 and the electronic device 122 logins into the account of the user 12 manually or automatically, the photo in the photo folder 1003 is viewable. Moreover, when the electronic device 122 is operated by the user 12 and the browsing history of any photo is viewed through the electronic device 122, the browsing history corresponding to the photo is also recorded in the browsing history recording module 1261 of the electronic device 122.

In addition to the function of searching and displaying all photos in the electronic device 121, if these photos contain at least one new photo (e.g. the photo 121b), the photo searching module 1263 of the photo sharing browser 126 is able to mark the new photo. Consequently, the user 12 can easily know which photos are new and which photos are captured or stored earlier.

Moreover, the photo sharing browser 126 further includes a photo editing module 1267. Through the photo editing module 1267, the user may edit the photo, for example trim, modify or decorate the photo. If the edited photo is different from the original photo, the edited photo may be stored in the photo folder 1003 of the photo sharing platform 100. Similarly, the photos 123a, 123b, 124a, 124b, 125a and 125b in the electronic devices 123, 124 and 125 may be stored and viewed by the above approaches.

Moreover, according to a plurality of counts of plural sharing channels used by the electronic device 121, 122, 123, 124 or 125, the transmission channel recommendation module 1264 of the photo sharing browser 126 generates a frequently-used channel list. After one sharing channel is selected from the frequently-used channel list by the user 12, the photo can be transmitted to another electronic device through the selected channel. For example, the electronic device 121 and the electronic device 122 are turned on, and these two electronic devices 121 and 122 are located near each other. In addition, both of the electronic device 121 and the electronic device 122 may be operated according to a Bluetooth transmission technology and a Wi-Fi transmission technology. In accordance with the direct photo sharing system of the present invention, either or both of the photo 121a and the photo 121b stored in the electronic device 121 and selected by the user 12 may be directly shared to the electronic device 122 through the Bluetooth sharing channel or the Wi-Fi sharing channel. Consequently, after several times of similar sharing actions are performed, the transmission channel recommendation module 1264 generates a frequently-used channel list. The Bluetooth transmission and the Wi-Fi transmission are included in the frequently-used channel list for allowing the user to directly select a sharing channel. The sharing channel is applied to share photos between the electronic device 121 and the electronic device 122. Consequently, the direct photo sharing system of the present invention may be also used to directly share photos between plural electronic devices without the need of transferring through the cloud server. Moreover, since the transmission channel recommendation module provides the user a frequently-used channel list to directly select a sharing channel, the users unfamiliar with the transmission approaches may easily operate any two electronic devices to share photos without the complicating operations and settings.

From the above discussions, the user may operate the direct photo sharing system of the present invention to manage all photo files. These photo files may be stored in any electronic device of the user or any user account for the internet. After any electronic device is operated by the user to be connected to the internet and the electronic device logins into the user account of the user, the photo sharing browser is enabled, so that all photos in the electronic device may be uploaded to the photo folder of the photo sharing platform. Afterwards, other electronic devices may be used to browse the photo files in the photo folder by the user at different places and at different time.

Moreover, the photo sharing browser of the direct photo sharing system of the present invention further includes a photo packing and playing module. Through the photo packing and playing module, the user may manage all photo files according to the attributes of the photo files. For example, by the photo packing and playing module, the plural photos in a photo package may be arranged in an order according to different packing conditions of the shared photo files (e.g. the photo attributes). Moreover, in response to a playing command, the photo packing and playing module will play the photo package according to a playing sequence. Consequently, the photo with a specified playing effect can be shared to a specified receiver. An example of the photo attribute includes but is not limited to a photo shot time, a people action in photo, a face image or a photo subject. Hereinafter, the present invention will be illustrated in more details.

FIG. 3 is a schematic functional block diagram illustrating a method for sharing and viewing the digital image file by the direct photo sharing system according to a second embodiment of the present invention. Please refer to FIGS. 1, 2 and 3. In this embodiment, the photos 121b, 122b, 123b, 124b and 125b stored in the electronic devices 121, 122, 123, 124 and 125 are successively browsed by the user 12 and indicated to be shared to the user 14. The browsing histories 1210, 1220, 1230, 1240 and 1250 corresponding to the photos 121b, 122b, 123b, 124b and 125b are recorded in the browsing history recording module 1261. The sharing indicators 1211, 1221, 1231, 1241 and 1251 are recorded in the photo selecting module 1262. According to the user account, the browsing histories 1210, 1220, 1230, 1240, 1250, the photos 121b, 122b, 123b, 124b, 125b and the sharing indicators 1211, 1221, 1231, 1241, 1251 are transmitted to and stored in the photo folder 1003 of the photo sharing platform 100. According to the sharing indicators 1211, 1221, 1231, 1241 and 1251, the sharing notification generating module 1004 issues one or more notification signals 127a to a receiver. In this embodiment, the receiver is the user 14.

In a case that the receiver (i.e. the user 14) has no user account for the direct photo sharing system, the notification signal 127a is sent to the receiver (i.e. the user 14) through an electronic mail box, a short message or a social networking website account. Under this circumstance, if the receiver (i.e. the user 14) wants to view the shared photo, the direct photo sharing system of the present invention can automatically install a photo sharing browser in the electronic device of the receiver (i.e. the user 14). Consequently, the receiver (i.e. the user 14) can view the shared photo through the photo sharing browser.

Whereas, in a case that the receiver (i.e. the user 14) has the user account for the direct photo sharing system, the notification signal 127a is shown on the photo sharing browser of the electronic device of the receiver (i.e. the user 14). In this embodiment, after any of the electronic devices 141, 142, 143, 144 and 145 is connected to the internet 10 and the photo sharing browser 126 is enabled according to the user account, one or more notification signals 127a are shown on the photo sharing browser of the electronic device 141, 142, 143, 144 or 145. Moreover, during the sharing indicators 1211, 1221, 1231, 1241, 1251 are successively transmitted to the photo folder 1003 of the photo sharing platform 100, if any electronic device 141, 142, 143, 144 or 145 of the user 14 has been connected to the network 10 and the photo sharing browser 126 has been enabled, the notification signals 127a are individually and successively shown on the photo sharing browser 126.

After the notification signal 127a is received, the user 14 may not act in response to the notification signal 127a. Alternatively, after the notification signal 127a is received, the user 14 may browse some or all of the photos 121b, 122b, 123b, 124b and 125b, or further download some or all of the photos 121b, 122b, 123b, 124b and 125b. If the user 14 browses the photo 121b, 122b, 123b, 124b or 125b through the photo sharing browser or the user 14 downloads the photo 121b, 122b, 123b, 124b or 125b, corresponding browsing history 1410, 1420, 1430, 1440 or 1450 is created and recorded in the browsing history recording module of the photo sharing browser and then transmitted to the photo sharing platform 100. The browsing history 1410, 1420, 1430, 1440 or 1450 is managed by the photo file management module 1001 and then stored in the photo folder 1003.

From the above discussions, the photos 121b, 122b, 123b, 124b and 125b stored in the photo folder 1003 may have individual browsing histories from different users. In addition, the user 12 for sharing the photos 121b, 122b, 123b, 124b and 125b can realize the preference degree of any photo 121b, 122b, 123b, 124b or 125b according to the information of the browsing histories. Moreover, the photo recommendation module 1002 of the photo sharing platform 100 may gather statistics and perform analysis on the browsing history of the photo, thereby generating at least one recommendation notification signal. The at least one recommendation notification signal may help the user realize the corresponding photos. Moreover, the user 14 for receiving the shared photo may edit any downloaded photo 121b, 122b, 123b, 124b or 125b through the photo editing module of the photo sharing browser. Under the sharing conditions set by the user 12, the edited photo and related browsing history may be uploaded to the photo folder 1003 by the user 14. Of course, the user 12 can acquire the information about related photo and browsing history. Accordingly, the close interaction between the sharer and the receiver, the enhanced relationship between the sharer and the receiver and the increasing pleasure of sharing photos are achieved through the photo sharing platform 100.

Moreover, the photo sharing platform 100 further includes a photo rating module 1005. The photo rating module 1005 may classify the plural photos to have at least one rating according to the browsing histories of the photos, so that the rating may facilitate the user 12 to know the browsing situations of these photos at the receiver's side. Alternatively, the photo rating module 1005 may classify the plural photos to have at least one rating according to the imaging quality of the photos, so that the rating may facilitate the user 12 to understand the imaging quality of these photos. That is, the contents of the recommendation notification signal are determined according to the user account. The recommendation notification signal may collect a portion or all of the browsing history to give reference to the user corresponding to the user account.

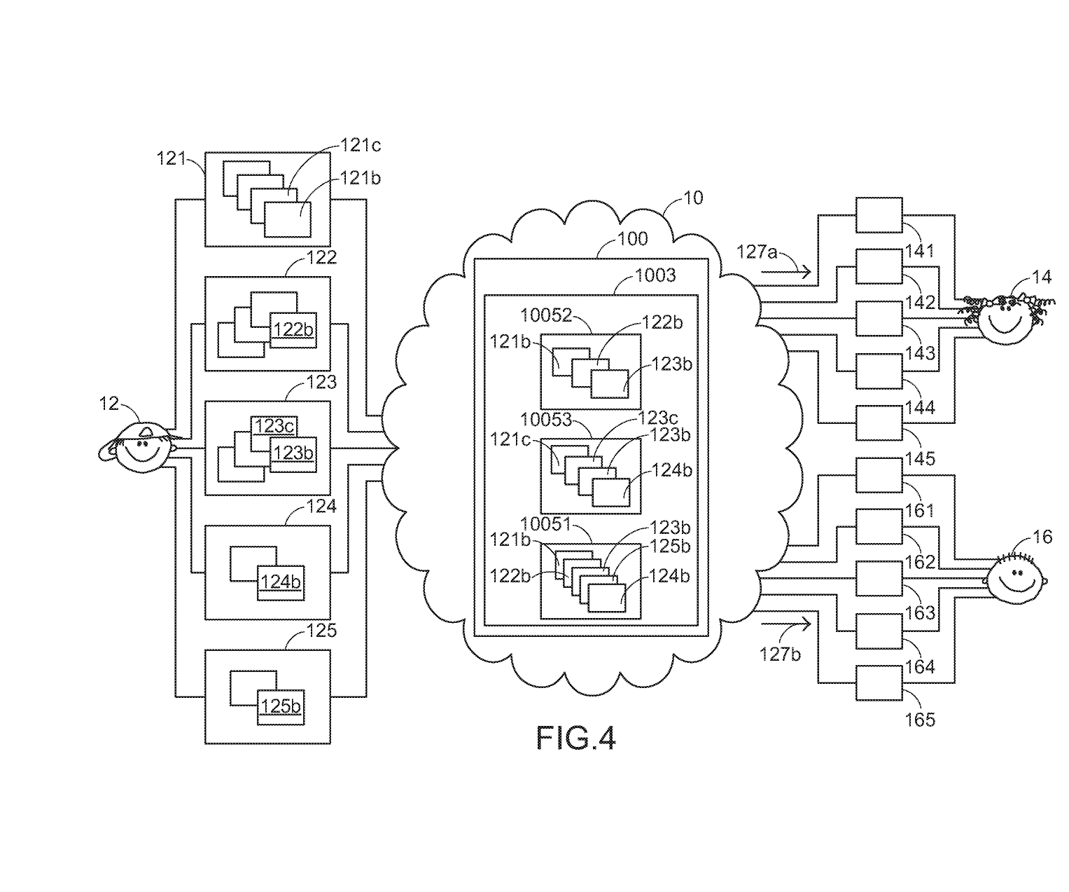

FIG. 4 is a schematic functional block diagram illustrating a method for sharing and viewing the digital image file by the direct photo sharing system according to a third embodiment of the present invention. Please refer to FIGS. 1, 3 and 4. In this embodiment, the photos to be shared to the user 12 and the 14 are not completely identical. For example, the photos 121b, 122b, 123b, 124b and 125b stored in the electronic devices 121, 122, 123, 124 and 125 are successively browsed by the user 12, manually packed into a photo package, and indicated to be shared to the user 12 himself (or herself). In addition, the packed photos 121b, 122b and 123b are indicated to be shared to the user 14, and the packed photos 121c, 123b, 123c and 124b are indicated to be shared to the user 16. The photos 121b, 121c, 122b, 123b, 123c, 124b, 125b, corresponding browsing histories and corresponding sharing indicators are stored in the photo folder 1003 of the photo sharing platform 100. Moreover, three different kinds of notification signals are generated. On the other hand, the photos 121b, 121c, 122b, 123b, 123c, 124b and 125b are classified into three sections 10051, 10052 and 10053. The section 10051 contains the photos 121b, 122b, 123b, 124b and 125b. The section 10052 contains the photos 121b, 122b and 123b. The section 10053 contains the photos 121c, 123b, 123c and 124b.

In a case that any of the electronic devices 141, 142, 143, 144 and 145 is operated by the user 14 to be connected to the internet 10 and a photo sharing browser 126 is installed in such an electronic device according to the user account, one or more notification signals 127a are shown on the photo sharing browser 126 of such an electronic device. Similarly, in a case that any of the electronic devices 161, 162, 163, 164 and 165 is operated by the user 16 to be connected to the internet 10 and a photo sharing browser 126 is installed in such an electronic device according to the user account, one or more recommendation notification signals 127b are shown on the photo sharing browser 126 of such an electronic device. Except that the photos in the section 10052 can be viewed by only the user 14 and the photos in the section 10053 can be viewed by only the user 16, the actions of the user 14 and the user 16 are similar to those of the second embodiment, and are not redundantly described herein. Moreover, the photos in the section 10051 (i.e. all of the browsed photos) can be viewed by only the user 12. From the above discussions, the photo files stored in the photo folder 1003 may have respective browsing histories and may correspond to one or more sharing indicators and one or more notification signals, so that the users for viewing or browsing corresponding photos are restricted. Moreover, the photo may only have a single backup copy without the need of being repeatedly stored. The combination of suitable browsing histories, sharing indicators and ratings may generate different notification signals to different users.

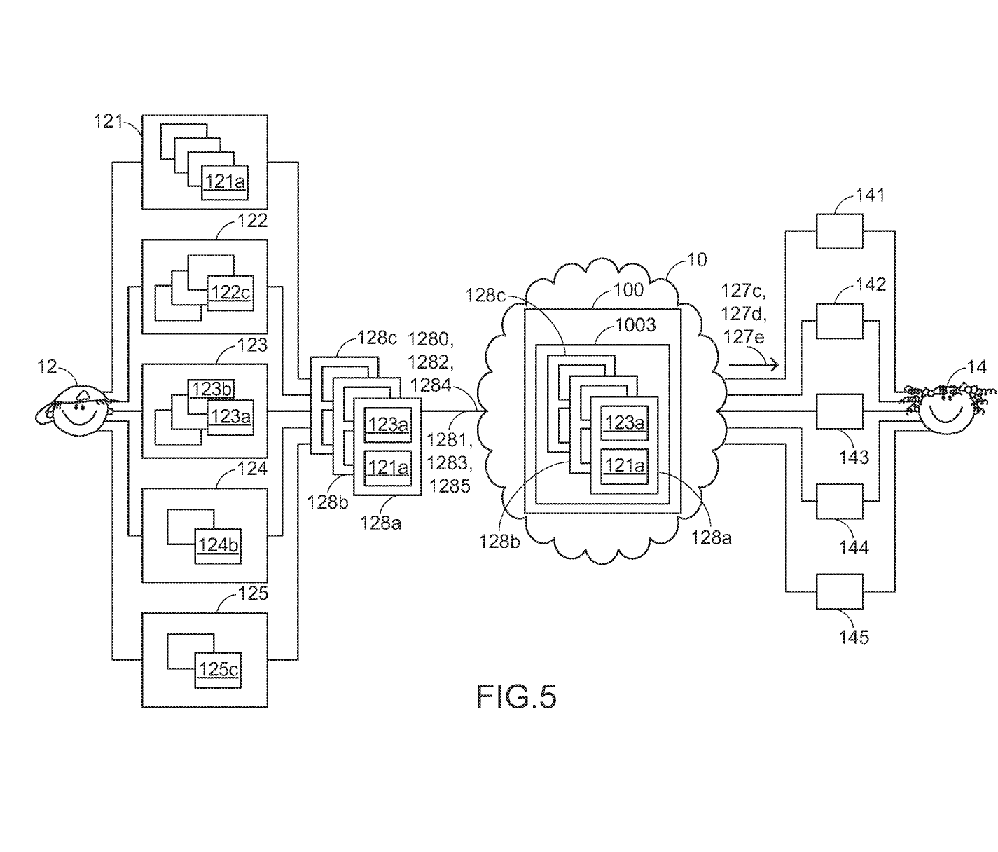

From the above discussions, through the photo packing and playing module 1266, the sharer may pack the photos into different photo packages that are transmitted to different users. Moreover, in accordance with the direct photo sharing system of the present invention, the sharer may set the packing condition of the to-be-shared photos. Consequently, the to-be-shared photos may be further classified into many photo packages having joint features in order to be shared to the sharer or other receivers. FIG. 5 is a schematic functional block diagram illustrating a method for sharing and viewing the digital image file by the direct photo sharing system according to a fourth embodiment of the present invention. Please refer to FIGS. 1, 3 and 5. In this embodiment, the photos 121a, 122c, 123a, 123b, 124b and 125c stored in the electronic devices 121, 122, 123, 124 and 125 of the user 12 are acquired at different time spots. For example, the photos 121a and 123a are shot at the same date; the photos 123b and 124b are shot at the same date; and the photos 122c and 125c are shot at the same date.

The photos 121a, 122c, 123a, 123b, 124b and 125c in the electronic devices 121, 122, 123, 124 and 125 may be browsed by the user 12 through the photo sharing browser 126. In addition, the packing condition may be set by the user 12 through the photo packing and playing module 1266 of the photo sharing browser 126. For example, the shot date may be set as the packing condition by the user 12. According to the packing condition, the photos 121a and 123a are classified as a first photo package 128a through the photo packing and playing module 1266. Similarly, the photos 123b and 124b are classified as a second photo package 128b, and the photos 122c and 125c are classified as a third photo package 128c. After the to-be-shared photos have been packed and recorded in respective browsing histories of the photos, the photos may be uploaded to the photo sharing platform 100 by the user 12. Meanwhile, the photo packages 128a, 128b, 128c, corresponding browsing histories 1280, 1282, 1284 and corresponding sharing indicators 1281, 1283, 1285 are transmitted from the photo sharing browser 126 to the photo sharing platform 100.

Moreover, the photos 121a, 122c, 123a, 123b, 124b, 125c, corresponding browsing histories 1280, 1282, 1284 and corresponding sharing indicators 1281, 1283, 1285 are stored in the photo folder 1003 of the photo sharing platform 100. Moreover, corresponding notification signals 127c, 127d and 127e are generated by the sharing notification generating module 1004, and then displayed on the photo sharing browser 126 of any electronic device 141, 142, 143, 144 and 145. The operations of the user 14 are similar to those illustrated in the above embodiments, and are not redundantly described herein. It is noted that the packing condition is not limited to the shot date. That is, the packing condition may be another predetermined packing condition, and the packing condition may be set by the user. For example, the subject of the birthday party or the graduation ceremony may be set as the packing condition.

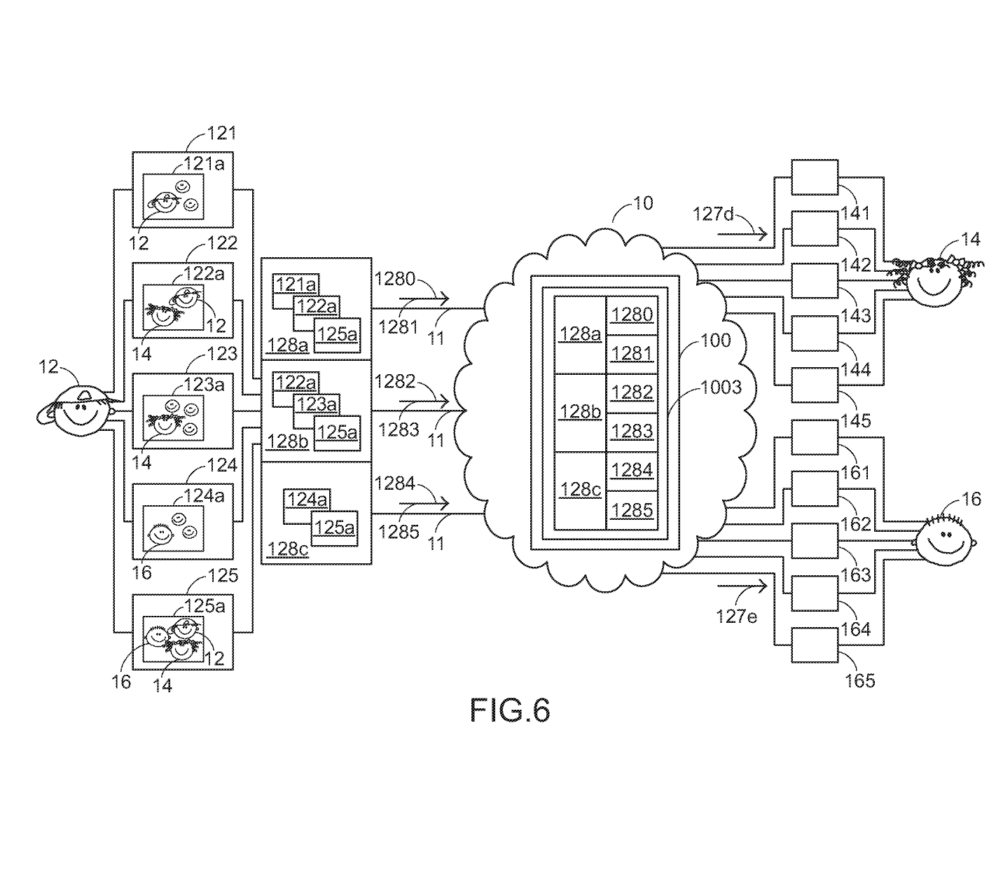

FIG. 6 is a schematic functional block diagram illustrating a method for sharing and viewing the digital image file by the direct photo sharing system according to a fifth embodiment of the present invention. Please refer to FIGS. 1, 3 and 6. In this embodiment, the photos 121a, 122a, 123a, 124a and 125a in the electronic devices 121, 122, 123, 124 and 125 of the user 12 have different image contents. For example, the photos 121a, 122a, 123a, 124a and 125a may be the photos taken all together: the image content of the photo 121a contains the user 12; the image content of the photo 122a contains the user 12 and the user 14; the image content of the photo 123a contains the user 14; the image content of the photo 124a contains the user 16; and the image content of the photo 125a contains the user 12, the user 14 and the user 16.

In a case that the photos 121a, 122a, 123a, 124a and 125a in the electronic devices 121, 122, 123, 124 and 125 are browsed by the user through the photo sharing browser 126, the photo packing and playing module 1266 may set the face feature as the packing condition of the photo package. That is, according to the face features of the user 12, the user 14 and the user 16, these photos may be packed into different photo packages through the photo packing and playing module 1266. For example, according to the face features (i.e. the packing conditions), the photos 121a, 122a and 125a are packed into a first photo package 128a by the photo packing and playing module 1266. Similarly, the photos 122a, 123a and 125a are packed into a second photo package 128b; and the photos 124a and 125a are packed into a third photo package 128c. Except for the displayed contents of the notification signals 127d and 127e, the following procedures are similar to those of the fourth embodiment (see FIG. 5). Since the face feature is set as the packing condition in the fifth embodiment, the notification signal including the face image of the photo sharer (i.e. the user 12) and the face image of the receiver is shown on the photo sharing browser of the receiver. Under this circumstance, the pleasure of sharing photos is enhanced, and the willing of browsing photos by the receiver is increased. In other words, the notification signal provided by the direct photo sharing system may be directly perceived through the senses. Consequently, when the notification signal shown on the photo sharing browser is browsed by the receiver, the receiver can realize the photos to be shared by the photo sharer and then determine whether the photo files are browsed or downloaded or not. In a case that the face feature of the shared photos is set as the packing condition, when the notification signal is generated by the photo sharing platform, an icon with the face feature of the photo sharer and the face feature of the receiver is predetermined to be included in the notification signal. Once the notification signal is seen by the receiver, the receiver can realize who the photo sharer is and which photo is to be shared.

In the above embodiments, the photo sharing browser of the direct photo sharing system has a photo packing and playing module for allowing the user the setting the packing condition of the photo package, so that the to-be-shared photos are classified into specified photo packages to be shared to specified receivers. The packing condition may be preset by the direct photo sharing system, and optionally adjusted by the sharer. Moreover, the photo packing and playing module may provide plural packing templates. According to the packing templates, the user may select and pack plural photos into the photo package, so that the narrative property of the shared photos is enhanced. For example, the photo sharing browser may provide several packing templates, wherein each packing temperate includes a space setting parameter, a time setting parameter, an animation effect setting parameter and a background music setting parameter. After the to-be-shared photos are classified into different photo packages, any photo package is put into the packing templates successively by the photo packing and playing module. Consequently, the playing effect is shown to be previewed by the sharer. The selected packing template by the sharer may be recorded in the browsing history of the photo package through the browsing history recording module. After the notification signal is viewed by receiver, if the receiver wants to browse the photos, the receiver may generate a playing command. In response to a playing command, the photo packing and playing module will play the photo package according to a playing sequence of the photo package. If the receiver wants to store the shared photos, the receiver may selectively store the photos only or store the packing template which is selected by the sharer.

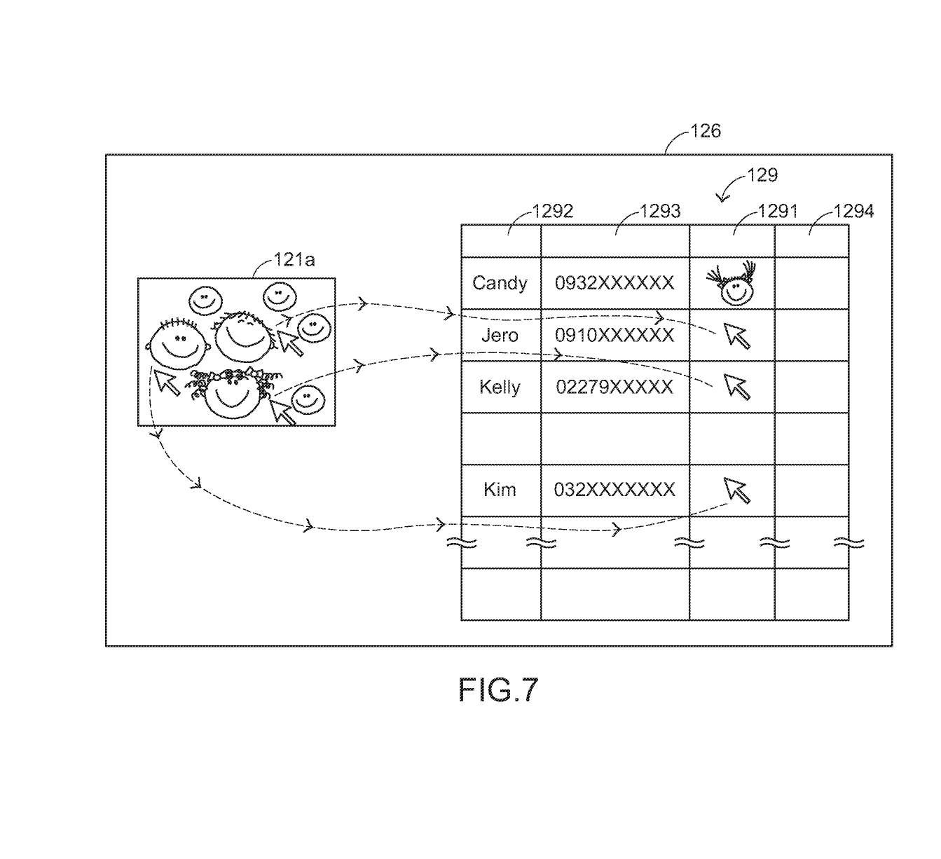

In accordance with the direct photo sharing system of the present invention, a sharing name list (i.e. the name list of the receivers for receiving the shared photos) may be directly perceived by the photo sharer. FIG. 7 is a schematic functional block diagram illustrating a way to create a sharing name list by the direct photo sharing system of the present invention. Please refer to FIGS. 1 and 7. When the photos in the electronic device 121 are browsed by the user 12 through the photo sharing browser 126, the user 12 may select a photo 121a (e.g. a group photo). Moreover, a face address book 129 is created through the face address book creating module 1265 of the photo sharing browser 126. The face address book 129 includes the information about face images 1291, names 1292, telephone numbers 1293 and plural name-related contact data 1294. The image of any person in the photo 121a may be added to the face image 1291 of the face address book 129 by a cursor-dragging operation through an input device (e.g. a mouse). If a face image is intended to be added to any existing face image 1291, the face address book creating module 1265 will compare the face image with the existing face image 1291 and inquire the user 12 whether the face image and the existing face image 1291 are the images of the same person. Alternatively, the face address book creating module 1265 may issue a prompt message to inform the user whether the existing face image 1291 is replaced. After the cursor-dragging operations are successively performed, the whole face address book 129 is established.

As mentioned above, the face address book 129 may be manually created. Moreover, after the new photos with face images are received and marked by the photo searching module 1263 of the photo sharing browser 126, if the photo sharing browser 126 measures that the face image is not included in the face address book 129 according to the face images, the face address book creating module 1265 will generate a new contact creating prompt for informing the user 12 whether the new photo needs to be immediately processed or not. Moreover, the face address book creating module 1265 may provide a function of assigning face identification codes. Consequently, different identification codes are assigned to the face images of all persons in the plural photos of the electronic device, and the identification codes are recorded in the face address book 129.

From the above discussions, the photo selecting module 1262 of the photo sharing browser 126 may be operated in a manual sharing mode or an automatic sharing mode. From the first embodiment to the fifth embodiment, the photo selecting module 1262 is operated in the manual sharing mode. When the photo selecting module 1262 is operated in the automatic sharing mode, the to-be-shared photos are classified by the photo sharing browser 126 according to the face images contained in the photos, and correlated with the face address book 129 including face images. Alternatively, the to-be-shared photos are classified by the photo sharing browser 126 according to the contents of the photos and the browsing histories. For example, all old group photos will be shared, and the new group photos are recommended to be shared.

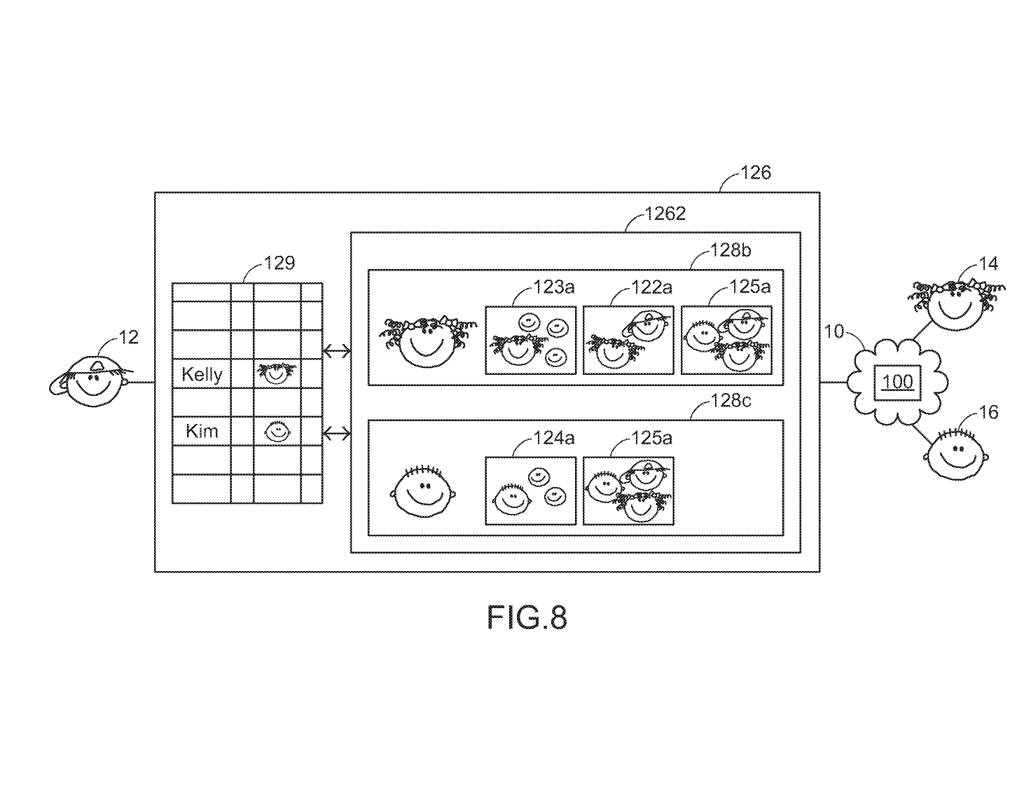

FIG. 8 is a schematic functional block diagram illustrating a method for sharing and viewing the digital image file by the direct photo sharing system according to a sixth embodiment of the present invention. Please refer to FIGS. 1, 6 and 8. In this embodiment, the face image is set as the packing condition by the user or predetermined as the packing condition through the photo sharing browser 126. According to the packing condition, the photos in at least one electronic device are divided into plural photo packages. Moreover, the photo selecting module 1262 of the photo sharing browser 126 may be operated in the automatic sharing mode. When the photo selecting module 1262 is operated in the automatic sharing mode, the to-be-shared photos are classified by the photo sharing browser 126 according to the face images contained in the photos, and correlated with the face address book 129 including face images. When the user 12 wants to share the photos, a sharing indicator is transmitted from the photo selecting module 1262 by only clicking the face image. Since the approach of sharing photos is directly perceived through the senses, the trouble of judging or determining the contact information of the receiver will be largely reduced, and the pleasure of sharing photos will be enhanced. That is, in the direct photo sharing system of the present invention, the user may create the face images of the contact persons in the contact name list as a portion of contact information of the contact person. When the user wants to share photos, the photos can be shared by simply clicking the face image. Under this circumstance, the purpose of directly sharing photos can be achieved with the need of opening another frame to input or indicate the contact person in response to another control command.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A direct photo sharing system for use in a network environment, said direct photo sharing system comprising:
a photo sharing browser installed in an electronic device for allowing a user to browse and share at least one photo by operating said electronic device, wherein said photo sharing browser comprises:
a browsing history recording module for recording a browsing history of said at least one photo; and
a photo selecting module for allowing said user to select a photo to be shared and issuing a sharing indicator; and
a photo sharing platform installed in a cloud server for storing said at least one photo and said browsing history of said photo, and transmitting said sharing indicator to a second electronic device, wherein said electronic device and said second electronic device are in communication with said cloud server through an internet, and said photo sharing platform comprises:
a photo file management module for managing at least one photo folder, wherein said photo is stored in said photo folder; and
a photo recommendation module for gathering statistics and performing analysis on said browsing history of said photo, thereby generating at least one recommendation notification signal.

2. The direct photo sharing system according to claim 1 wherein said photo sharing browser further comprises a photo searching module for searching and displaying all photos of said electronic device, wherein if all of said photos include at least one new photo, said at least one new photo is marked by said photo searching module.

3. The direct photo sharing system according to claim 1 wherein said photo sharing browser further comprises a transmission channel recommendation module, wherein according to a plural of counts of sharing channels used by said electronic device, said transmission channel recommendation module generates a frequently-used channel list, wherein after one sharing channel is selected from the frequently-used channel list by said user, said photo is transmitted to said second electronic device through said selected sharing channel, wherein said sharing channel is a Wi-Fi sharing channel, a 3G sharing channel or a Bluetooth sharing channel.

4. The direct photo sharing system according to claim 1 wherein said photo selecting module is operated in a manual sharing mode or an automatic sharing mode, wherein when said photo selecting module is operated in said automatic sharing mode, plural to-be-shared photos are classified according to face images contained in said to-be-shared photos.

5. The direct photo sharing system according to claim 1 wherein said browsing history includes a name of said user who browses said photo, a count of said photo browsed, a time length of browsing said photo in each browsing action, an action of magnifying, minifying or moving said photo, a count of said photo downloaded to any electronic device, a name of a folder of any electronic device which stores said photo, and a count of said photo re-shared.

6. The direct photo sharing system according to claim 1 wherein a content of said recommendation notification signal is determined according to a user account.

7. The direct photo sharing system according to claim 1 wherein said photo sharing platform further comprises a sharing notification generating module for issuing a notification signal to a receiver.

8. The direct photo sharing system according to claim 7 wherein if said receiver has no user account, said notification signal is sent to said receiver through an electronic mail box, a short message or a social networking website account, wherein if said receiver has a user account, said notification signal is shown on a photo sharing browser of said receiver.

9. The direct photo sharing system according to claim 8 wherein when said notification signal is shown on said photo sharing browser of said receiver, said notification signal contains a face image of said user and a face image of said receiver.

10. The direct photo sharing system according to claim 1 wherein said photo sharing browser further comprises a face address book creating module for allowing said user to create a face address book, wherein said face address book includes information about face images, names, telephone numbers and plural name-related contact data.

11. The direct photo sharing system according to claim 10 wherein said face images are added to said face address book by a cursor-dragging operation.

12. The direct photo sharing system according to claim 10 wherein after a new photo with a face image is received by said photo sharing browser, if said face image is not included in said face address book, a new contact creating prompt is generated by said face address book creating module.

13. The direct photo sharing system according to claim 10 wherein said face address book creating module further provides a function of assigning face identification codes, wherein different identification codes are assigned to said face images in said plural photos of said electronic device, and said identification codes are recorded in said face address book.

14. The direct photo sharing system according to claim 1 wherein said photo sharing platform further comprises a photo rating module, wherein by said photo rating module, plural photos in said photo sharing platform are classified to have at least one rating.

15. The direct photo sharing system according to claim 14 wherein said rating is determined according to said browsing history of said photo.

16. The direct photo sharing system according to claim 14 wherein said rating is determined according to an imaging quality of said photo.

17. The direct photo sharing system according to claim 1 wherein said photo sharing browser further comprises a photo packing and playing module for selecting plural photos and packing said selected photos into a photo package according to a photo attribute, and generating a space setting parameter, a time setting parameter, an animation effect setting parameter and a background music setting parameter, and playing said photo package according to a playing sequence of the photo package in response to a playing command.

18. The direct photo sharing system according to claim 17 wherein said photo attribute is a photo shot time, a people action in photo, a face image or a photo subject.

19. The direct photo sharing system according to claim 17 wherein said photo packing and playing module provides plural packing templates, wherein according to said packing templates, plural photos are selected by said user to be packed into said photo package.

20. The direct photo sharing system according to claim 17 wherein said photo package is transmitted to said photo sharing platform and shared to at least one indicated receiver.

21. The direct photo sharing system according to claim 1 wherein said photo sharing browser further comprises a photo editing module for editing said photo.
